(19) United States
(12) Patent Application Publication
(10) Pub. No.: US 2015/0035248 A1
(43) Pub. Date: Feb. 5, 2015

(54) EXTENDABLE BICYCLE

(71) Applicant: SMART TRIKE . PTF. LTD., Singapore (SG)

(72) Inventors: Yoram Baron, Moshav Nir Israel (IL); Shlomi Avital, Moshav Rinatia (IL); Amit Nir, Moshav Rinatia (IL)

(21) Appl. No.: 14/383,410

(22) PCT Filed: Mar. 24, 2013
(86) PCT No.: PCT/IB2013/052333

§ 371 Date: Sep. 5, 2014

Related U.S. Application Data
(60) Provisional application No. 61/618,965, filed on Apr. 2, 2012.

(51) Int. Cl. B62K 15/00

(52) U.S. Cl. CPC B62K 15/00; B62K 2015/003
USPC 280/259

(57) ABSTRACT

The present invention relates to an extendable bicycle comprising: (a) at least two wheels (100,500), each having an axis (120), and each capable of rotating around its own axis; (b) an extendable handle bar (200) for steering said extendable bicycle; (c) an extendable chair (400); and (d) an extendable frame (300) for pivotally holding said two wheels, and for supporting said extendable handle bar and said extendable chair, where the extendable frame can be extended from a first configuration to at least a second configuration for extending the length between said axes of said at least two wheels.

### FIELD OF THE INVENTION

The present invention relates to the field of riding vehicles. More particularly, the invention relates to an extendable riding vehicle.

### BACKGROUND OF THE INVENTION

Balancing and coordination skills are essential for learning how to ride a two wheel bicycle. Nevertheless, acquiring these skills is not an easy task for beginner cyclists, especially young children. A known approach for achieving bicycle riding skills is to use a set of training wheels, which is attached to the bicycle's rear wheel assembly. However, one major drawback is that the learner tends to lean on the training wheels for support much like riding a tricycle, creating a dependency for said training wheels, whereby preventing the learner from developing the necessary balancing skills. It could take a long time before the learner is willing to wean off these training wheel devices. Another disadvantage is that since there are many different bicycle models and sizes for the beginner, the manufacturing and stocking of each specific type of training wheel device for said models and sizes is costly.

Certain training methods involve the providing of a training scooter which does not have pedals. A beginning cyclist can learn to balance and coast on these training scooters, but must switch to a different bicycle with pedals to learn balancing and coasting while peddling. The switching to a different bicycle which has a different feel and weight is believed to inhibit the learning process. Additionally, these training scooters do not position the beginning cyclist's legs to approximate the position of the legs when learning to balance and coast while peddling.

U.S. Pat. No. 7,798,513 describes an apparatus for training a beginning cyclist to ride a bicycle, which includes providing a bicycle with detachable pedals and at least a portion of the crank arms, and attaching guard shields on the remaining portions of the crank arms. The described training bicycle can be converted to a training mode where at least a portion of the crank arms and pedals are removed. The crank shields protect the cyclist's legs and feet from getting snagged during the balancing step of learning. Nevertheless, the described apparatus is inefficient.

Is would therefore be desired to propose a system void of the problems discussed above.

### SUMMARY OF THE INVENTION

It is an object of the present invention to provide a riding vehicle that can be transformed from a running bicycle into a pedal bicycle.

It is another object of the present invention to provide a bicycle that can be extended from a small bicycle for smaller cyclists into a larger bicycle for bigger cyclists.

It is still another object of the present invention to provide a bicycle that can be transformed from one arrangement to another arrangement for accommodating the growing rider.

It is still another object of the present invention to provide a bicycle that can be easily transformed from one arrangement to another without requiring additional tools.

Other objects and advantages of the invention will become apparent as the description proceeds.

The present invention relates to an extendable bicycle comprising: (a) at least two wheels, each having an axis, and each capable of rotating around its own axis; (b) an extendable handle bar for steering said extendable bicycle; (c) an extendable chair; and (d) an extendable frame for pivotally holding said two wheels, and for supporting said extendable handle bar and said extendable chair, where the extendable frame can be extended from a first configuration to at least a second configuration for extending the length between said axes of said at least two wheels.

Preferably, the extendable frame comprises a main frame and an inner pipe.

Preferably, the extendable frame can be extended by pulling the inner pipe from the main frame.

The present invention also relates to a riding vehicle transformable from a running bicycle into a pedaling bicycle comprising: (a) at least two wheels, each having an axis, and each capable of rotating around its own axis; (b) a handle bar for steering said vehicle; (c) a chair; (d) at least one pedal; (e) at least one pedal arm connected to said pedal; (f) a frame for pivotally holding said two wheels, and supporting said handle bar, said chair, and said at least one pedal arm; (g) means for folding said pedal into said frame; and (h) means for securing said pedal from unfolding spontaneously from said frame.

### BRIEF DESCRIPTION OF THE DRAWINGS

In the drawings:

FIG. 1 is a schematic diagram, from a left side view, of the extendable bicycle folded into its running bicycle arrangement, according to an embodiment of the invention.

FIG. 2 is a schematic diagram, from an upper view, of the extendable bicycle folded into its running bicycle arrangement, according to an embodiment of the invention.

FIG. 3 is a schematic diagram, from a right side view, of the extendable bicycle folded into its running bicycle arrangement according to an embodiment of the invention.

FIG. 4 is a schematic diagram, from a right side view, of the extended bicycle in its running bicycle arrangement, according to an embodiment of the invention.

FIG. 5 is a schematic diagram, from a right side view, of the extended bicycle in its pedaling bicycle arrangement, according to an embodiment of the invention.

FIG. 6 is a schematic diagram, from an upper view, of the extendable bicycle in its pedaling bicycle arrangement according to an embodiment of the invention.

FIG. 7 is a schematic diagram, from an enlarged right side view, of the pedaling bicycle arrangement, according to an embodiment of the invention.

FIG. 8a is a schematic diagram, from an enlarged right side view, of the pedaling bicycle arrangement, according to an embodiment of the invention.

FIG. 8b is a schematic diagram, from an enlarged right side view, of the axis cover 610, according to an embodiment of the invention.

FIG. 9a is a schematic diagram, from an enlarged right side view, of the pedaling bicycle arrangement, according to an embodiment of the invention.

FIG. 9b is a schematic diagram, from an enlarged right side view, of the element 645 and nut 640, according to an embodiment of the invention.

FIG. 10 is a schematic diagram, from an enlarged right side view, of the running bicycle arrangement, according to an embodiment of the invention.

FIG. 11a is a schematic diagram, from an enlarged left side view, of the pedaling bicycle arrangement, according to an embodiment of the invention.

FIG. 11b is a schematic diagram, from an enlarged left side view, of the running bicycle arrangement, according to an embodiment of the invention.

FIG. 12a is a schematic diagram, from an enlarged right side view, of the axis cover, according to an embodiment of the invention.

FIG. 12b is a schematic diagram, from an enlarged right side view, of the back of the axis cover, according to an embodiment of the invention.

### DETAILED DESCRIPTION OF PREFERRED EMBODIMENTS

Hereinafter, parts, elements and components that are depicted in more than one figure are typically referenced by the same numerals.

The terms of “front”, “rear”, “down”, “up”, “bottom”, “upper”, “horizontal”, ^{“}vertical^{”} or any reference to sides or directions are used throughout the description for the sake of brevity alone and are not meant to be limiting in any way.

The terms “bolt” and “pin” are used throughout the description interchangeably.

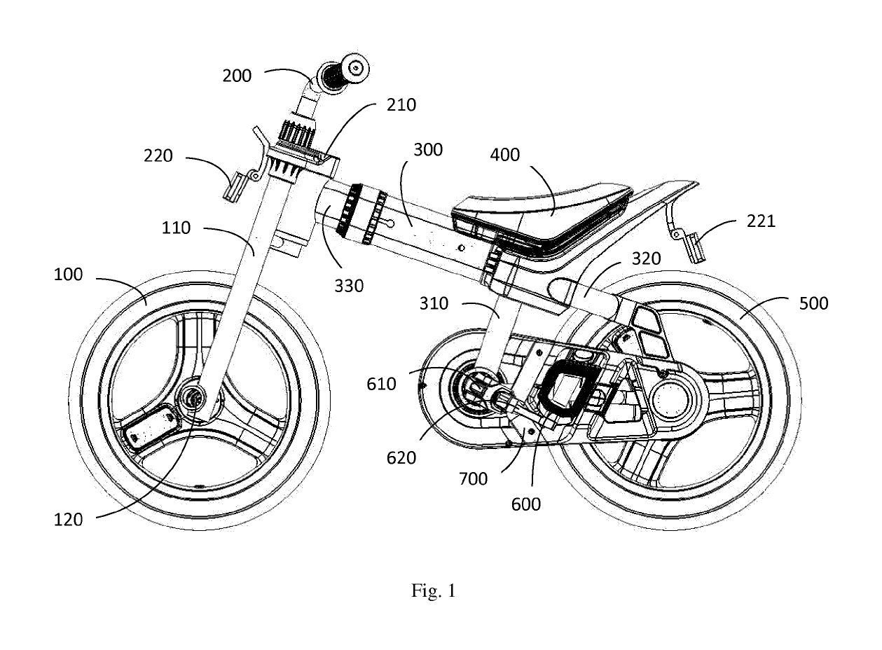

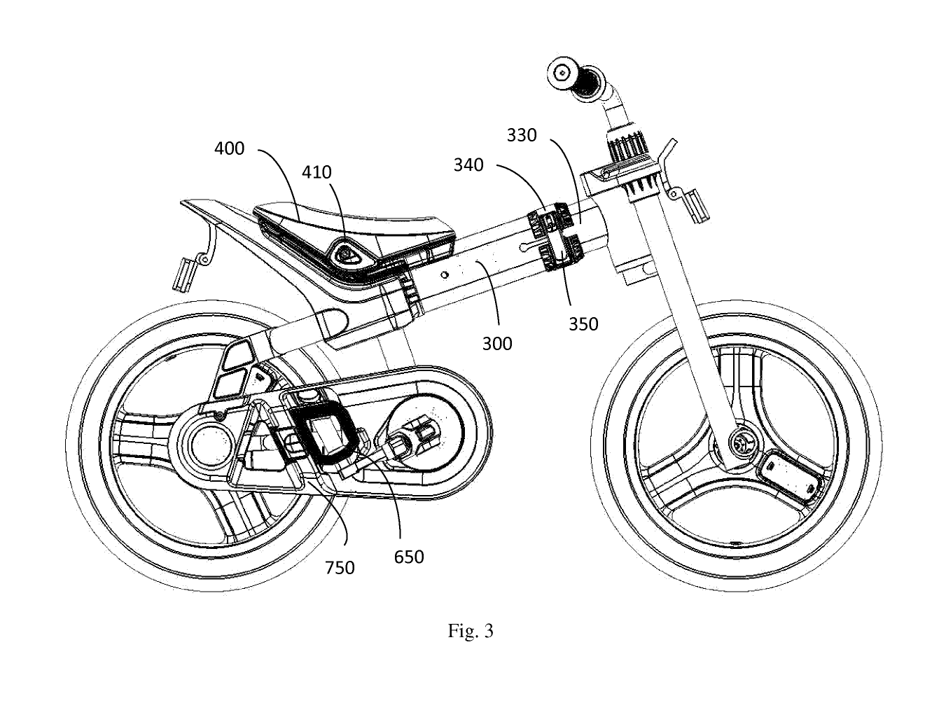

FIG. 1 is a schematic diagram, from a left side view, of the extendable bicycle folded into its running bicycle arrangement, according to an embodiment of the invention. In this arrangement the pedal 600 is folded into the left framework 700 in an arrangement that eliminates the pedal 600 interference with the legs of the rider while running. The left framework 700 secures the folding state of the pedal. In this embodiment, the counterpart pedal (not shown) on the other side is folded as well, as will be described in relation to FIG. 3. The folded pedals allow the beginning cyclist to use the bicycle as a running bike for learning to balance and coast. The folded pedal 600 is connected to the pedal arm 620 which is held in proximity to the main axis pin (not shown) located under cover 610. The main axis pin (not shown) is pivotally held by the frame bar 310, which supports the main axis pin and allows it to revolve. The rear wheel 500 axis pin (not shown), which holds the rear wheel 500 and allows it to rotate, is pivotally held by the frame bar 320. The frame bars 320 and 310 are both connected to the main frame 300 which also supports the chair 400 of the runner/rider. The main frame 300 secures an inner pipe 330 which holds the hinge 210 which allows the right and left rotating of: the handle bars 200 and front wheel 100. In one embodiment the handle bars 200 are connected by pipes 110 to the axis pin 120 of the front wheel 100. Any number of pipes 110 may connect the handle bars 200 and the axis of wheel 120, as long as the handle bars 200 may be used for controlling the rotating right and left of the front wheel 100, i.e. controlling the steering of the bicycle. In one embodiment a flash light or a front light reflector 220 may be added. In one embodiment a flash light or a back light reflector 221 may be added.

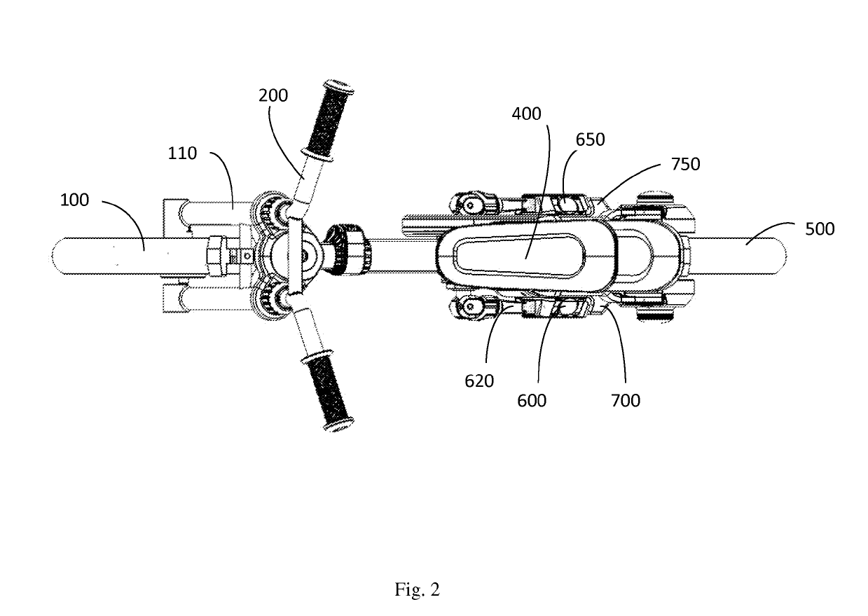

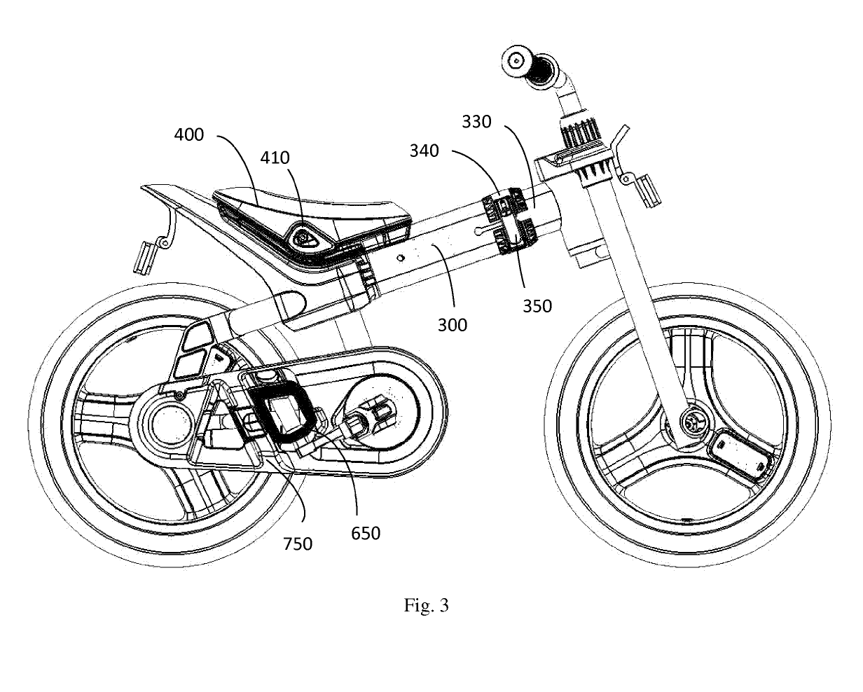

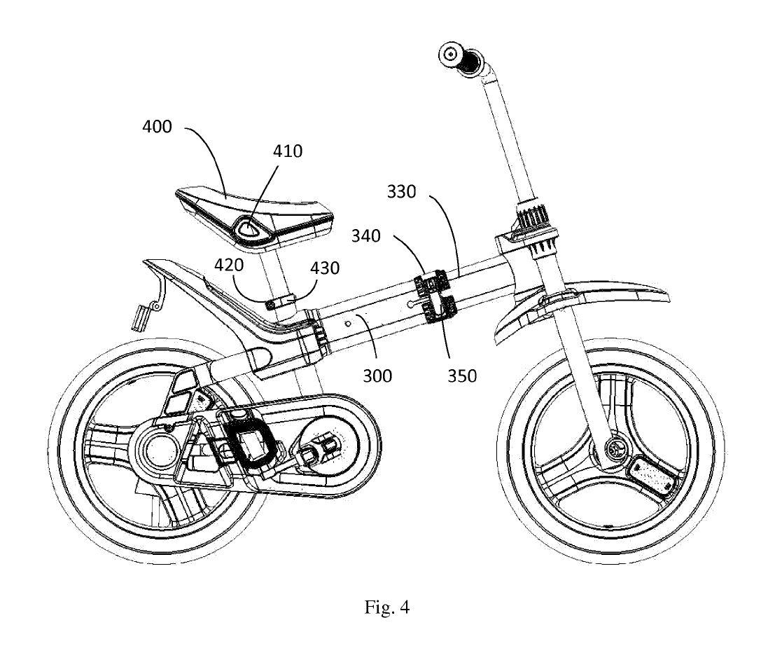

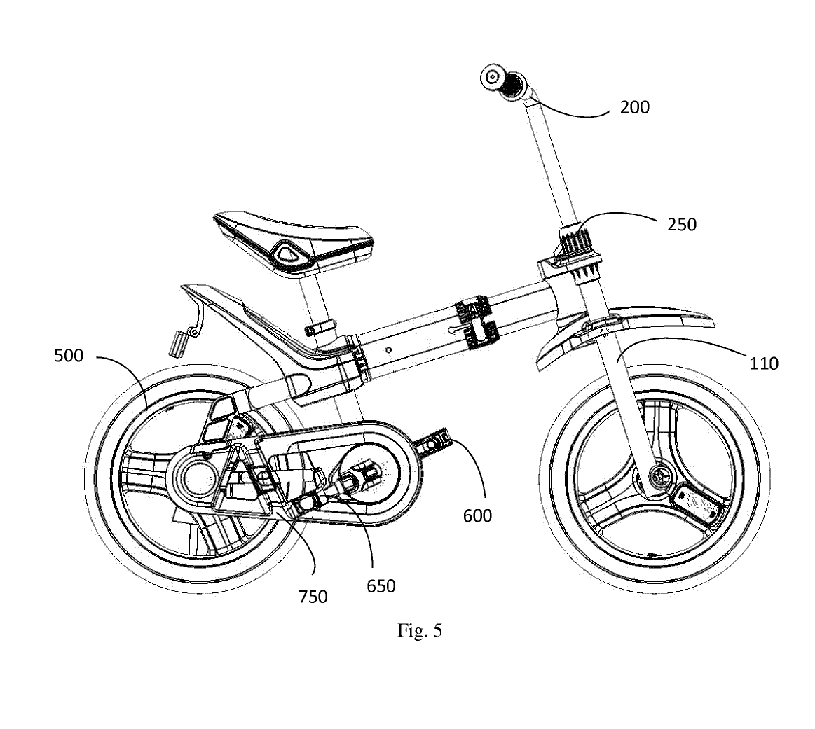

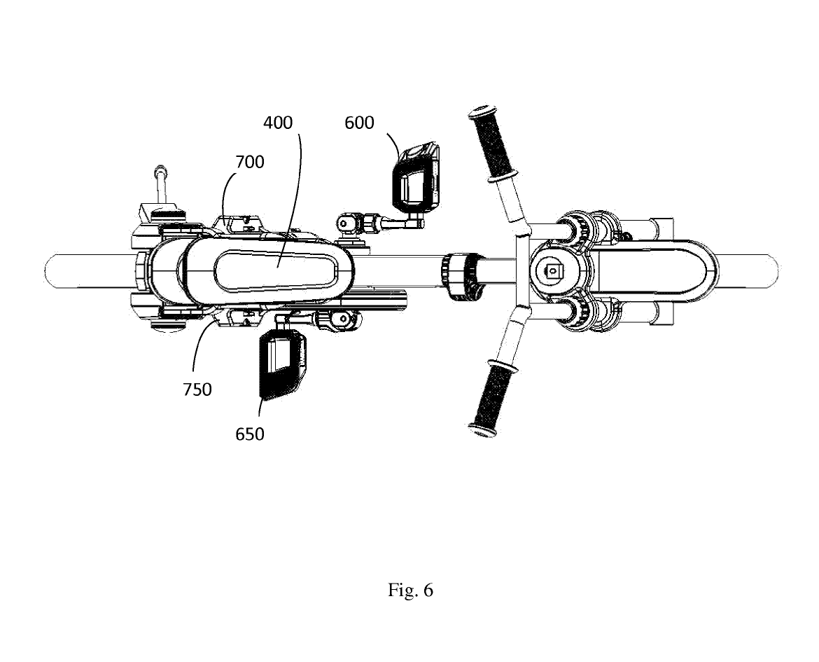

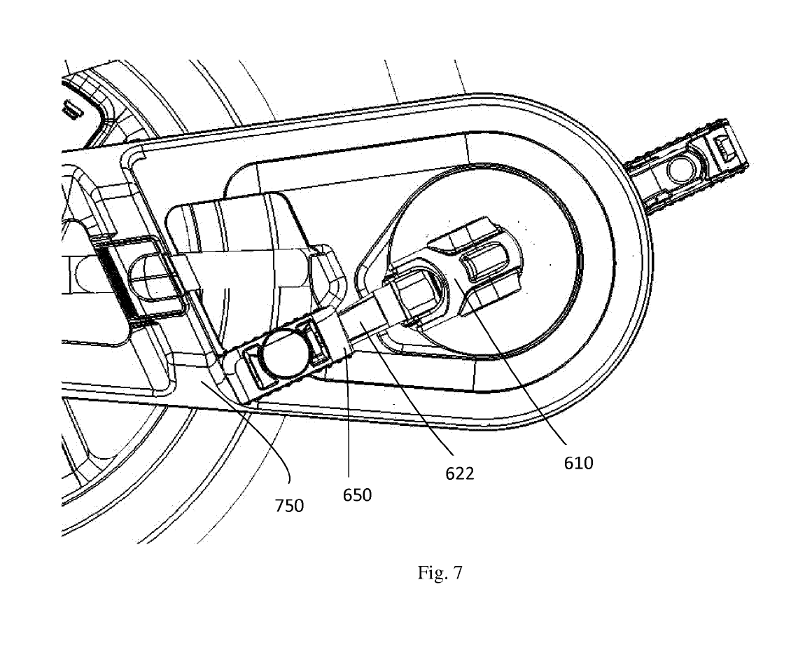

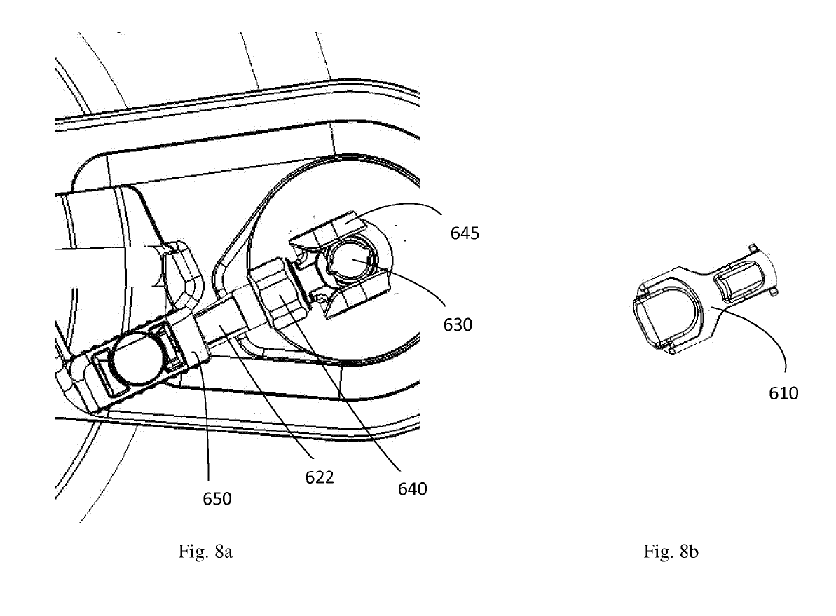

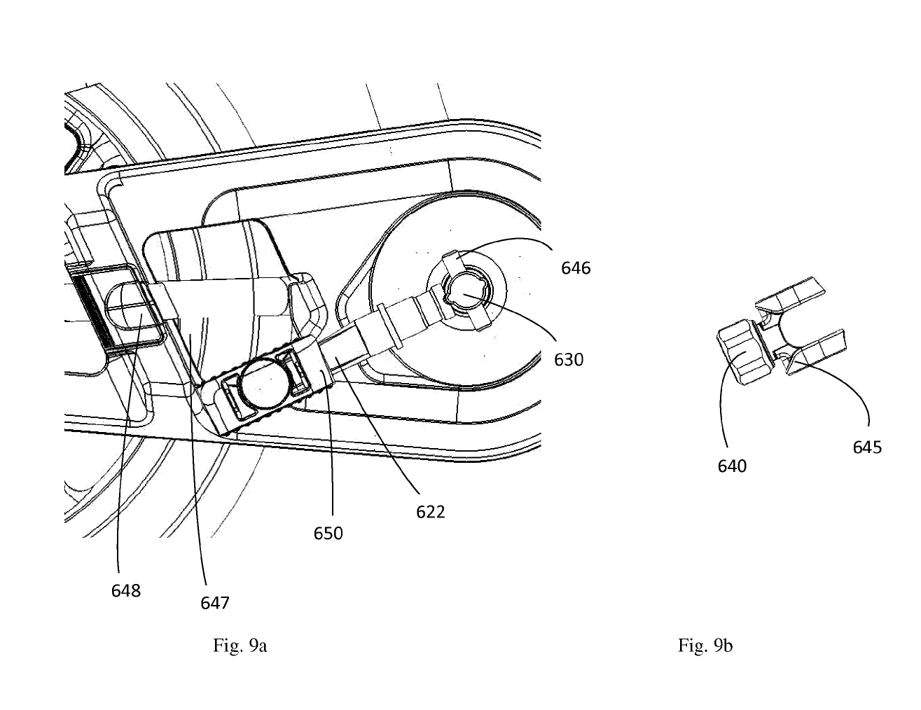

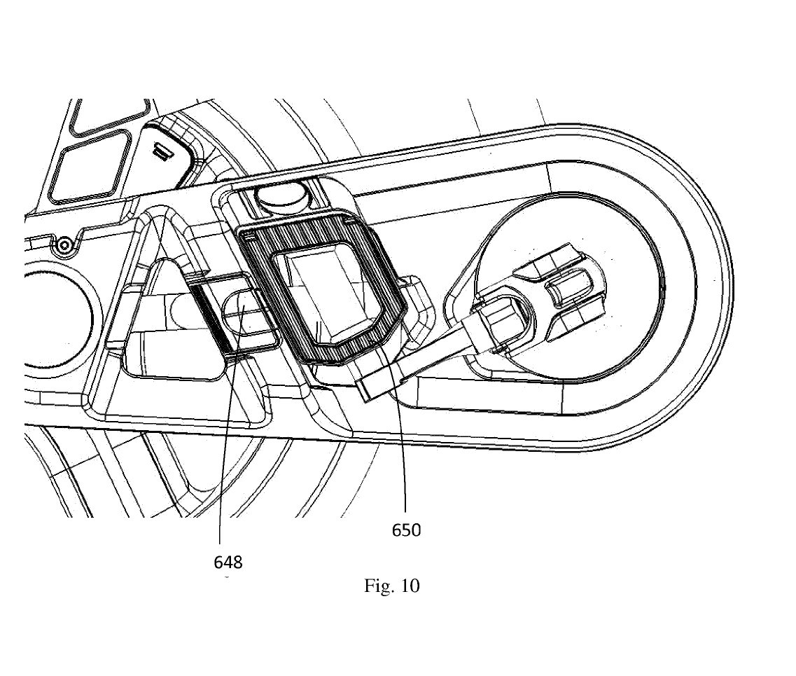

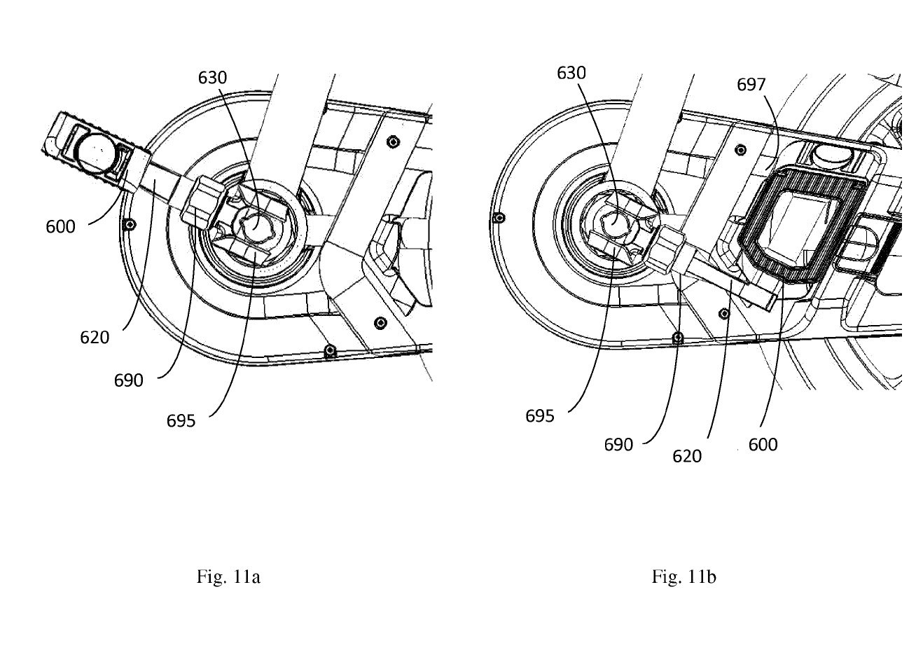

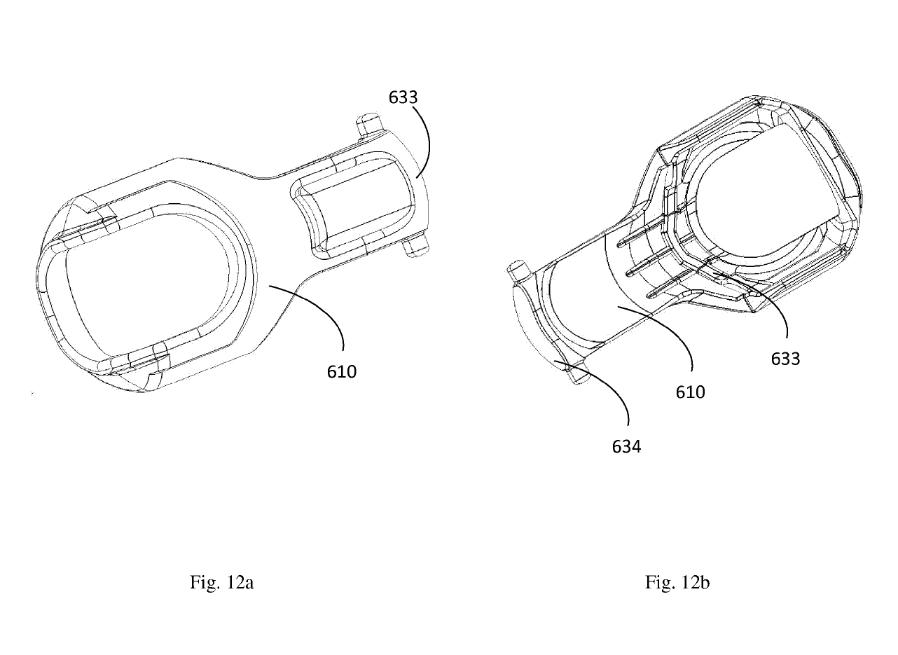

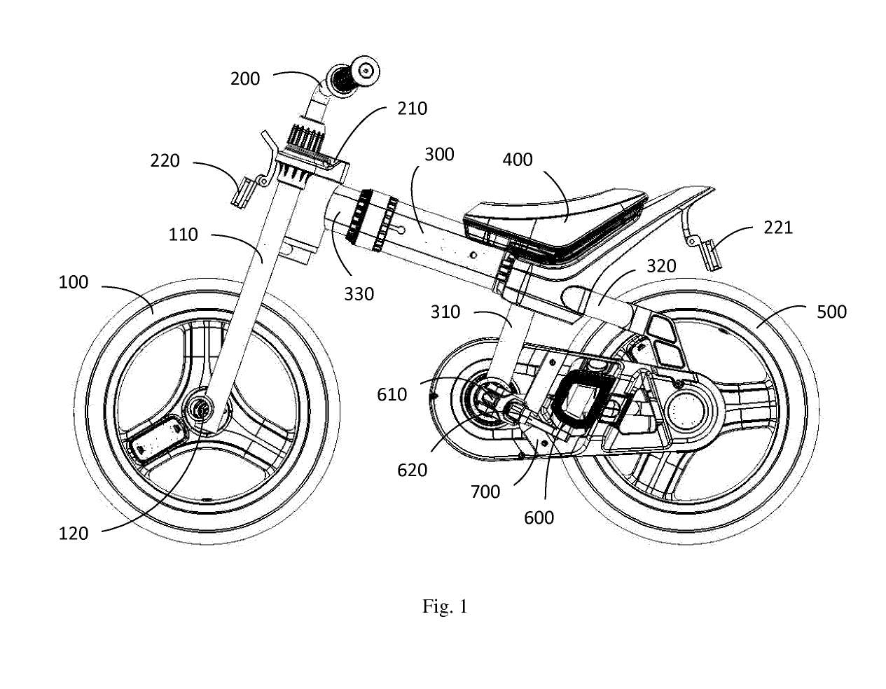

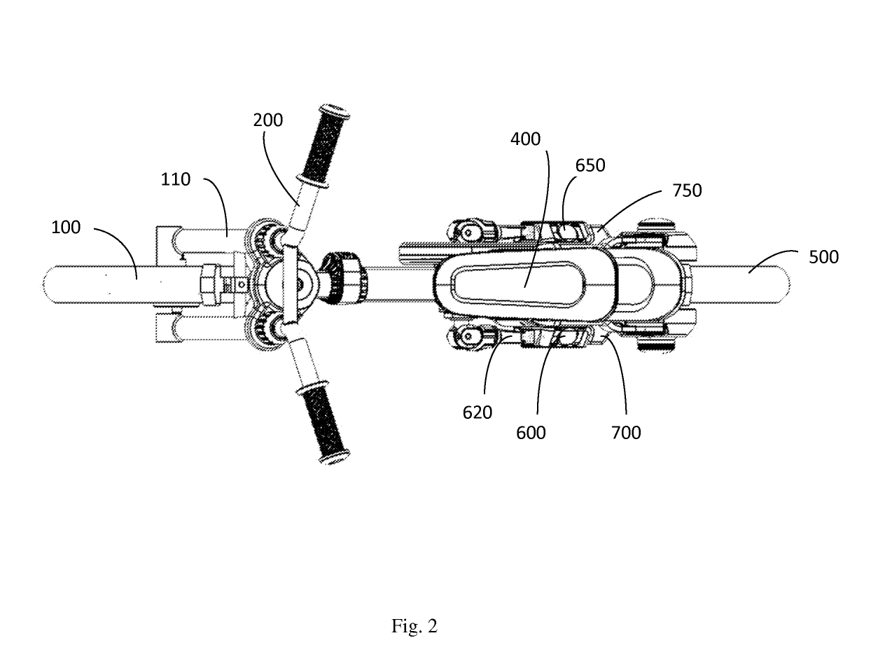

FIG. 2 is a schematic diagram, from an upper view, of the extendable bicycle folded into its running bicycle arrangement, according to an embodiment of the invention. Some of the parts illustrated in this diagram have been described above in relations to FIG. 1 and are referenced with the same numerals as in FIG. 1 such as parts: 100, 110, 200, 500, 620 and other parts as well. As described in relations to FIG. 1 the left pedal 600 is folded into the left framework 700. In addition, the right pedal 650 is folded as well into the right framework 750. Both pedals are folded for eliminating their interference with the legs of the rider while he is running. The rider may sit on the chair 400 and push the bicycle forward by pushing with his legs on the floor. This practice of running and riding can teach the rider to balance himself on the bicycle easily and comfortably.

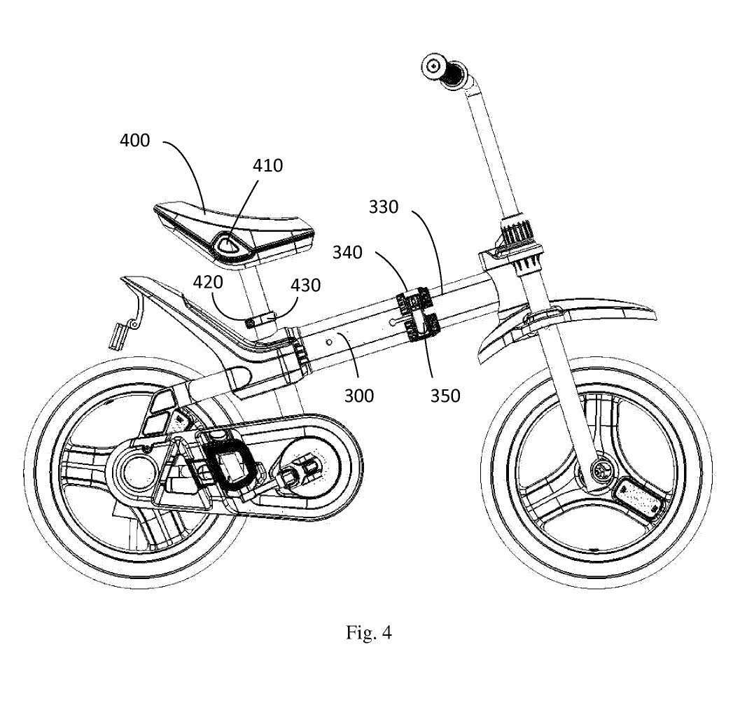

FIG. 3 is a schematic diagram, from a right side view, of the extendable bicycle folded into its running bicycle arrangement according to an embodiment of the invention. In this diagram the chair 400, as described in relations to FIG. 1, has an opening 410 in which a screw driver or an adjustable spanner or any other tool may be inserted inside for adjusting the height of the chair, as will described further in relations to FIG. 4. In addition, the main frame 300 upper end, i.e. the end that is closer to the handle bar, is held by a clamp 340 which is secured by a lever 350. The clamp 340 purpose, among others, is to secure the holding of the inner pipe 330 in relations to the main frame 300. The clamp 340 grip may be loosened by pulling out lever 350, after which inner pipe 330 may be pulled from inside the frame 300, effectively extending the length of the bicycle.

As described in relations to FIG. 2 and shown in FIG. 3, the pedal 650 is folded into the right framework 750 in an arrangement that eliminates the pedal 650 interference with the legs of the rider while he is running.

FIG. 4 is a schematic diagram, from a right side view, of the extended bicycle in its running bicycle arrangement, according to an embodiment of the invention. In this diagram the bicycle is in its running bike arrangement similar to the arrangement described in relations to FIG. 3, however, in this arrangement the bicycle is also extended to accommodate a taller rider. In this diagram the chair 400 has been pulled up to accommodate the taller rider. As described in relations to FIG. 3 the chair 400 has an opening 410 in which a screw driver can be inserted for releasing the screw 420, or any other fastening means, which secures the clamp 430. Once the clamp 430 has been loosened the chair may be pulled upward and fitted for the taller rider's convenience. After fitting the chair 400 at the right height, the clamp 430 may be fastened again using the screw 420. The horizontal length of the bicycle may be extended as well by pulling lever 350 and loosening clamp 340. Once clamp 340 has been loosened the inner pipe 330 may be pulled from the main frame 300 and adjusted according to the needs of the rider. After the right length is set the clamp 340 may be fastened again using lever 350.

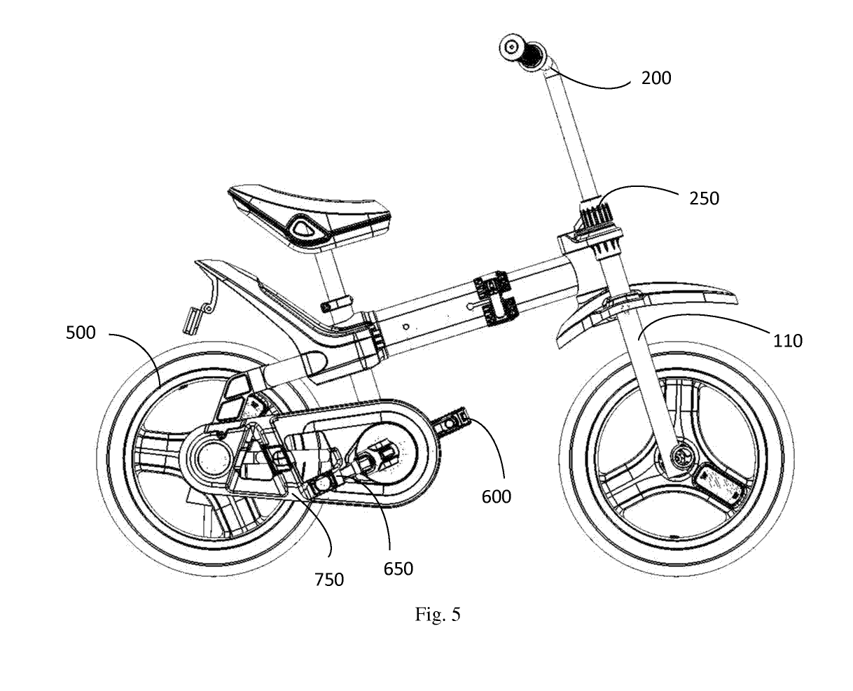

FIG. 5 is a schematic diagram, from a right side view, of the extended bicycle in its pedaling bicycle arrangement, according to an embodiment of the invention. The terms “pedal arrangement”, “pedaling arrangement”, and “pedal bicycle” are meant to describe an arrangement of a bicycle that is propelled by rotating the pedals of the bicycle. In this embodiment the pedals 600 and 650 are unfolded and they are set at the side of the bicycle for pedaling. Thus the rider can ride the bicycle by rotating the pedals 600 and 650 which in turn rotate their axis (not shown), which rotates the wheel 500 using a revolving chain (not shown) located inside the framework 750, similar to the workings of the prior art bicycle. The other parts and components of the bicycle are similar to the described in relations to FIG. 4.

In one embodiment, the extending feature of the bicycle is used for accommodating the growing user. Thus the bicycle may be bought initially for a rider who is a child and changed periodically in relations to the rider's growth. For example the chair 400, as described in relations to FIGS. 1-5 can be pulled up and extended to accommodate the growing rider. As described in relations to FIG. 3, the chair 400 can have an opening 410 in which a screw driver, or any other means, can be inserted for releasing the fastening means, such as clamp 430 of the chair for extending the chair, after which the clamp 430 may be fastened again for securing the chair in the extended configuration. Thus, the chair 400 may be held upward and fitted in one configuration of any number of extended configurations for the growing rider. In other embodiments other extending means may be used for extending the chair's height. The handle 200 may be extended as well by loosening the nuts 250 and pulling the handle 200 upwards from inside the fork 110. In other embodiments other extending means may be used for extending the handle's height. The horizontal length of the bicycle may be extended as well by pulling lever 350 and loosening clamp 340. Once clamp 340 has been loosened the inner pipe 330 may be pulled from the main frame 300 and adjusted according to the needs of the growing rider. After the right length is set the clamp 340 may be fastened again using lever 350. In other embodiments other extending means may be used for extending the length between the axis of the front wheel and the axis of the back wheel. Thus the bicycle may be changed from a first configuration which can accommodate a small rider to a second configuration which can accommodate a bigger rider.

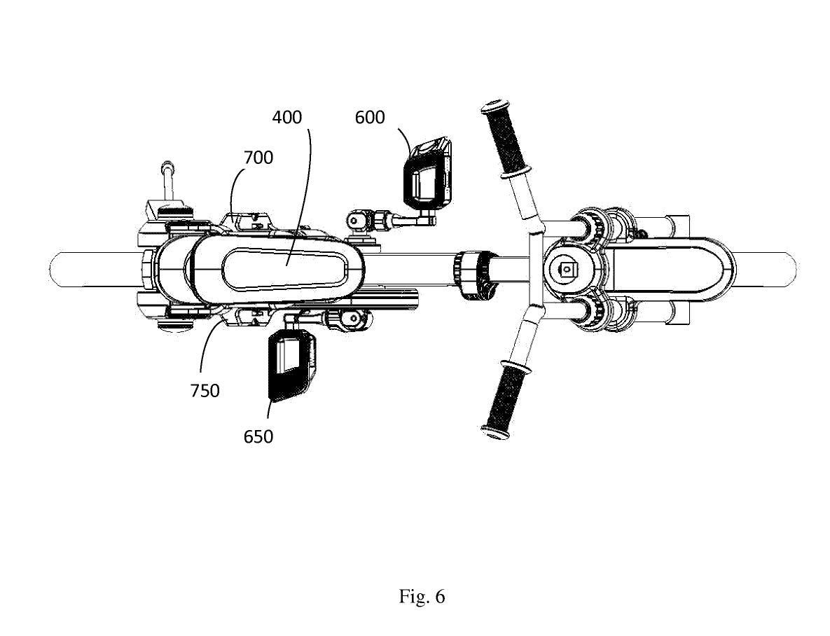

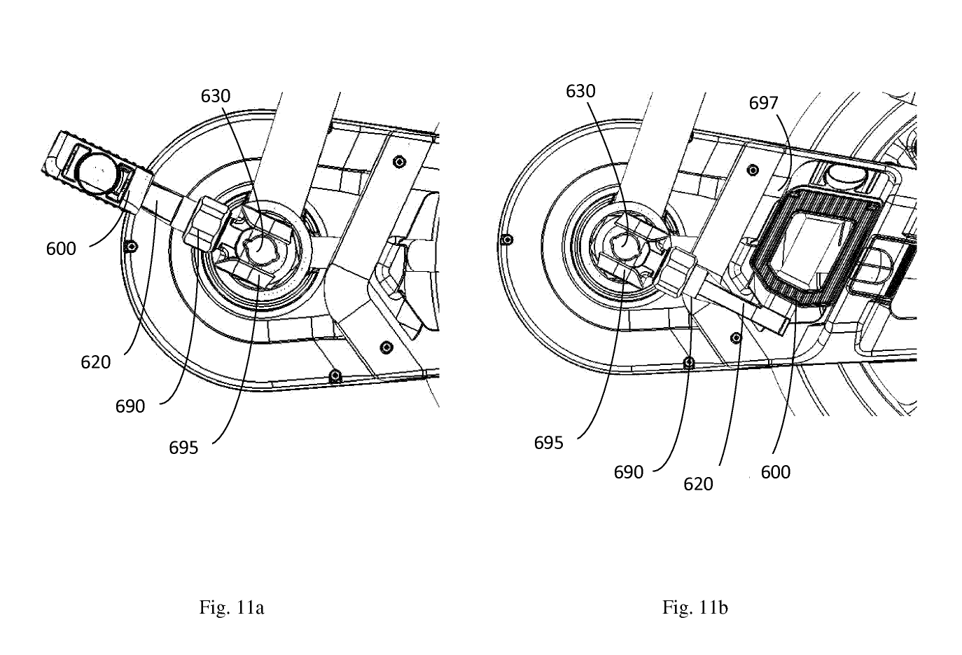

FIG. 6 is a schematic diagram, from an upper view, of the extendable bicycle in its pedaling bicycle arrangement according to an embodiment of the invention. As described in relations to FIG. 5 the pedal 600 is unfolded from the left framework 700. In addition, the pedal 650 is also unfolded as well from the right framework 750. Both pedals are unfolded for allowing the rider to pedal and ride the bicycle. The rider may sit on the chair 400 and pedal the bicycle forward as known in the prior art bicycles. The unfolding will be described later in relations to FIG. 11a and FIG. 11b.

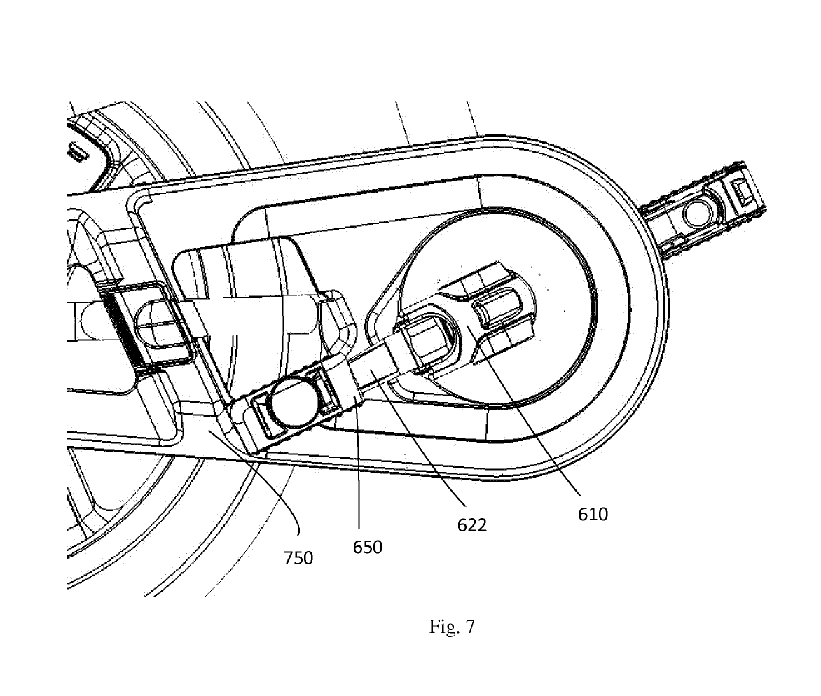

FIG. 7 is a schematic diagram, from an enlarged right side view, of the pedaling bicycle arrangement, according to an embodiment of the invention. As described in relations to FIG. 5 the pedal 650 is unfolded from the framework 750. As described in relations to FIG. 1 the pedal 650 is connected to the pedal arm 622 which is connected to the axis pin (not shown) under the cover 610.

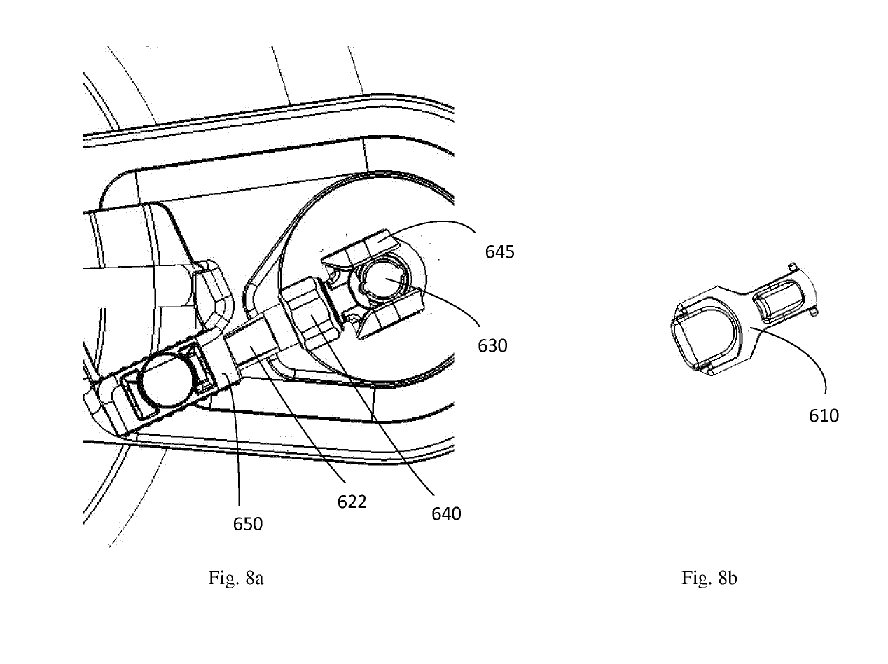

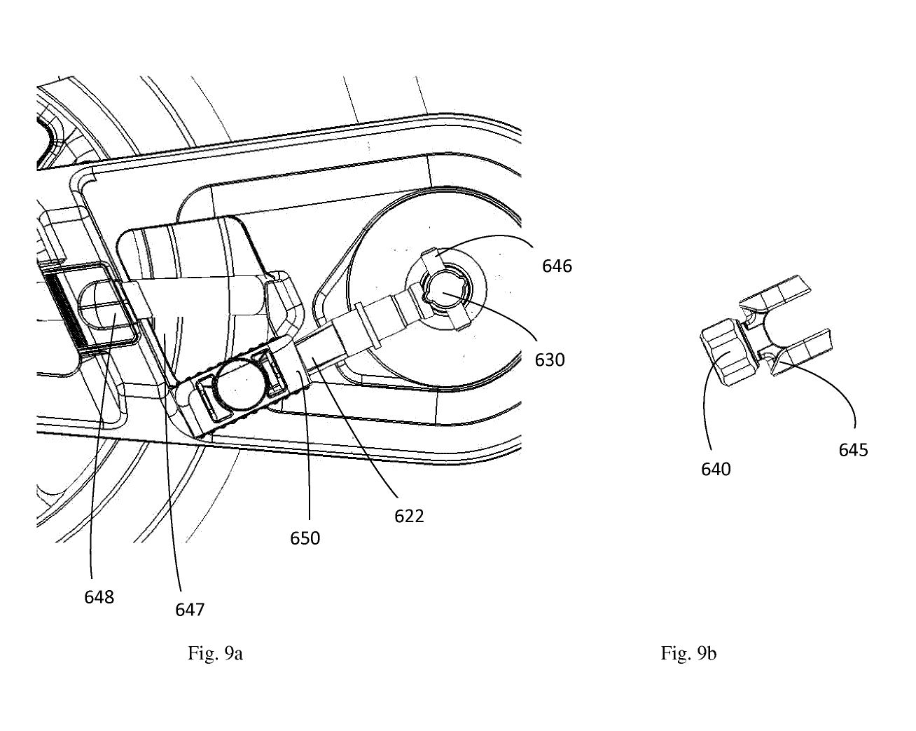

FIG. 8a is a schematic diagram, from an enlarged right side view, of the pedaling bicycle arrangement, according to an embodiment of the invention. In this view the axis cover 610, described in relations to FIG. 7, is removed for revealing the axis pin 630. The pedal 650 is connected to the pedal arm 622 which is fastened by the nut 640 to element 645 which is connected by a bolt (not shown) to the axis bolt 630. FIG. 8b is a schematic diagram, from an enlarged right side view, of the axis cover 610, according to an embodiment of the invention. FIG. 9a is a schematic diagram, from an enlarged right side view, of the pedaling bicycle arrangement, according to an embodiment of the invention. In this view the element 645 and nut 640, described in relations to FIG. 8a, are removed for the sake of brevity. The pedal 650 is connected to the pedal arm 622 which is held in close proximity to the axis bolt 630 by bolt 646. In order to fold the pedal 650 the pedal arm 622 must be loosened from the axis pin 630. Once the pedal arm 622 is loosened it may be turned in 90° around it own axis, effectively aligning the pedal 650 with its socket. When the pedal 650 is aligned with its socket 647 it may be pushed in the socket 647 where the clip 648 holds the pedal 650 in place. The clip 648 may be held with a spring or any other elastic arrangement which allows it to move in order to allow the insertion of pedal 650 and the holding of the pedal 650 once it has been inserted. FIG. 9b is a schematic diagram, from an enlarged right side view, of the element 645 and nut 640, according to an embodiment of the invention. In order to fold the pedal 650, described in relations to FIG. 9a, the nut 640 must be turned in relations to element 645 and the pedal arm 622 must be loosened from the axis pin 630.

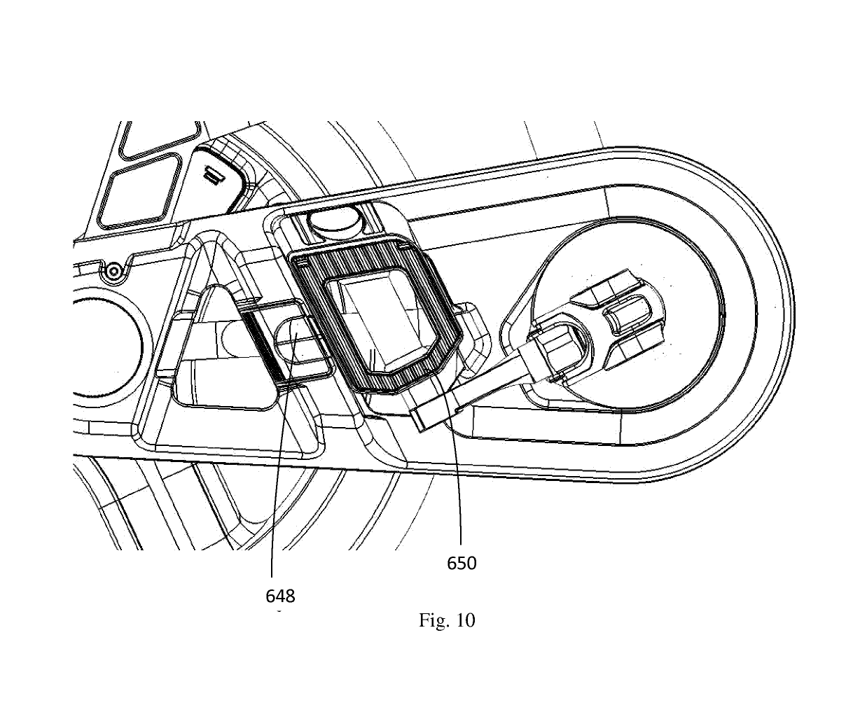

FIG. 10 is a schematic diagram, from an enlarged right side view, of the running bicycle arrangement, according to an embodiment of the invention. In this embodiment the pedal 650 is shown in its folded state held by clip 648.

FIG. 11a is a schematic diagram, from an enlarged left side view, of the pedaling bicycle arrangement, according to an embodiment of the invention. In this view, similar to the described in relations to FIG. 8a, the axis cover is removed for revealing the axis pin 630. The pedal 600 is connected to the pedal arm 620 which is fastened by the nut 690 to element 695 which is connected by a bolt (not shown) to the axis bolt 630. FIG. 11b is a schematic diagram, from an enlarged left side view, of the running bicycle arrangement, according to an embodiment of the invention. In this view, similar to the described in relations to FIG. 11a, the axis cover is removed for revealing the axis pin 630, however, in this diagram the pedal 600 is folded into its socket 697. Similarly to the described in relations to FIG. 9a the folding of this pedal is done by turning the nut 690 and loosening the pedal arm 620, however, once the pedal arm 620 is loosening the pedal arm should be turned 90° up, around its own axis, and then the pedal arm and element 695 should be moved 180° around the axis 630, effectively aligning the pedal 600 with its socket 697. In one embodiment both pedal arms 620 and 622 may each be moved 180° around the axis 630.

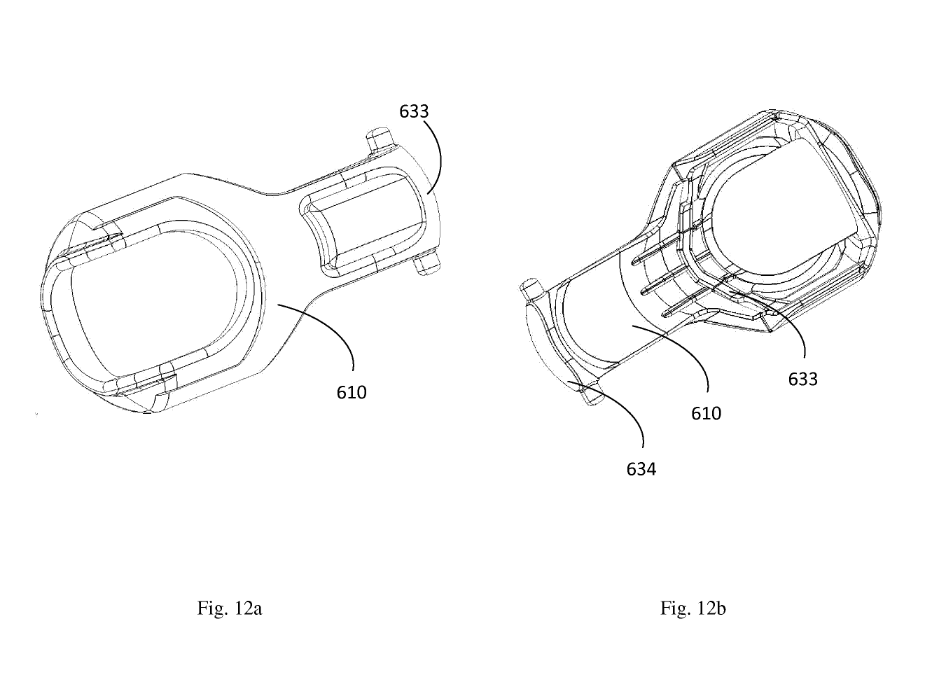

FIG. 12a is a schematic diagram, from an enlarged right side view, of the axis cover 610, according to an embodiment of the invention. FIG. 12a is a schematic diagram, from an enlarged left side view, of the axis cover 610, according to an embodiment of the invention. FIG. 12b is a schematic diagram, from an enlarged right side view, of the back of axis cover 610, according to an embodiment of the invention. In one embodiment the inside of the cover 610 may have a fence like addition 633 which has a partial outer shape of the nut 640, as described in relations to FIG. 8a. Thus the cover 610 may be used for turning nut 640. The turning of nut 640 may be done buy pulling the side 633 of the cover 610 and turning the cover 610 into a place where the addition 633 covers a part of the nut 640. Once the addition 633 of nut 640 is covered, the cover 610 may be turned in the direction for opening the nut 640. After the folding or unfolding of the pedal the cover 610 may be used for closing nut 640 as well. In one embodiment, both pedal arms, right and left, may have the described cover 610.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1-4. (canceled)

5. A riding vehicle transformable from a running bicycle into a pedaling bicycle comprising:
a front wheel, having an axis, and capable of rotating around its own axis;
a rear wheel, having an axis, and capable of rotating around its own axis;
a handle bar for steering said vehicle;
a chair;
at least one pedal;
at least one pedal arm connected to said pedal;
a frame for pivotally holding said front wheel and said rear wheel, and supporting said handle bar, said chair, and said at least one pedal arm;
means for folding said pedal into said frame; and
means for securing said pedal from unfolding spontaneously from said frame.

6. A vehicle according to claim 5 where the handle bar is an extendable handle bar.

7. A vehicle according to claim 5 where the chair is an extendable chair.

8. A vehicle according to claim 5 where the frame is an extendable frame capable of extending from a first configuration to at least a second configuration for extending the length between the axis of the front wheel and the axis of the rear wheel.

9. A bicycle according to claim 8, where the extendable frame comprises a main frame and an inner pipe.

10. A bicycle according to claim 9, where the extendable frame can be extended by pulling the inner pipe from the main frame.
